(19) United States
(12) Patent Application Publication
(10) Pub. No.: US 2026/0227321 A1
(43) Pub. Date: Aug. 6, 2026

(54) MULTI-WELL PLATE FOR MICROSCOPY

(71) Applicant: APPLIKATE TECHNOLOGIES, INC., Washington, DC (US)

(72) Inventors: Eben Olson, North Haven, CT (US); Glenn DiCostanzo, Woodbury, CT (US); Piotr Paluch, New York, NY (US); Richard Torres, Weston, CT (US)

(21) Appl. No.: 19/531,269

(22) Filed: Feb. 5, 2026

Related U.S. Application Data
(60) Provisional application No. 63/755,043, filed on Feb. 6, 2025.

(51) Int. Cl. G01N 21/03

(52) U.S. Cl. CPC G01N 21/0303; G01N 2021/0357; G01N 2021/0364; G01N 2021/0375; G01N 2021/0382

(57) ABSTRACT

The disclosure provides a multi-well plate which may include a plurality of wells, each well having sidewalls and a bottom comprising an index-matched optical window; and a set of physical features to secure a tissue specimen cassette over one of the plurality of wells. Methods of using the plates are also disclosed.

### TECHNICAL FIELD

The disclosure relates to an apparatus for microscopy of tissue samples and methods of use thereof.

### BACKGROUND

Histological examination and processing of tissue specimens are fundamental to biomedical research and diagnostic pathology. Traditional methods often involve handling individual samples separately through various stages of fixation, embedding, sectioning, and staining—a process that is both labor-intensive and prone to variability. Unfortunately, this may lead to inconsistent, inaccurate, or delayed results. Moreover, identifying and tracking multiple samples concurrently through these stages poses significant challenges.

Typically, a specimen is placed in a labeled cassette, processed through fluid exchanges, embedded in wax, then sliced to produce thin sections for viewing under the microscope. These slices need to be individually labeled and there are considerable risks in mislabeling, requiring multiple checks throughout the process to reduce these highly consequential errors.

The development of a multi-well plate for cell cultures represented a major advancement in experimental consistency and throughput; however, because tissue samples traditionally need to be individually sectioned on a specialized reciprocating blade assembly to produce thin slices, analogous systems for tissue specimens are not employed. Notably, current standard tissue processing cassettes do not permit direct imaging of uncut and un-embedded samples. Existing solutions aimed at simultaneous processing of multiple tissue samples only allow positioning inside the tissue processing instruments. In the converse, current solutions for direct imaging of uncut and un-embedded samples do not envision associating samples with any cassettes used in processing and do not offer the efficiency and consistency gains of multi-well plates.

Interest in performing this task has emerged from new techniques which enable sufficient clearing of the tissue that high resolution laser microscopy, such as multiphoton imaging, can produce optical sections for detailed microscopic examination and diagnostic evaluation.

There are other aspects that available options also do not adequately address such as adaptability for un-sectioned tissue specimens of various thicknesses and sizes, from core needle biopsies to those accommodated by extra-large tissue cassettes.

The increasing need for high-throughput tissue analysis in clinical research, drug development, and personalized medicine has revealed an opportunity for innovation in this area. It is expected that the combination of a standard tissue processing cassette with a multi-well plate will allow for the secure containment of samples, thereby enabling better imaging using methods for intact tissue imaging to provide benefits in efficiency and error reduction. More generally, the design and introduction of a multi-well tissue specimen plate with features tailored specifically to address practical challenges of high throughput processing and imaging is expected to greatly enhance efficiency, repeatability, and reliability in histological studies, thereby providing higher quality data and reductions in labeling errors, all while saving time and resources.

### SUMMARY

The invention provides apparatus for containing multiple tissue samples for microscopy. The samples are contained within individual wells or reservoirs. Each well has sidewalls and an optically transparent bottom. In some embodiments, the bottom comprises an index-matched optical window. The sample microscopy plates also include a set of features for securing a tissue specimen cassette over the individual wells.

In some embodiments, the set of features includes one or more projections on a central wall and a resistance feature on a peripheral wall. In some embodiments, the set of features further comprises a lateral overhang to limit any vertical displacement of the cassette.

In some embodiments, the set of features includes a cassette backstop separate from the central wall. In these embodiments, the set of features may also include an indentation near the backstop to facilitate unloading of the cassette. Further, the set of features may also include one or more bumps along a sidewall to provide lateral resistance or tension.

The sample microscopy plates may also be used with a transporter and/or microscope stage. For these applications, the plate may include a mechanical linkage for picking up, transporting, or otherwise moving the microscopy plate. In some embodiments, the mechanical linkage comprises an overhang on the top surface of the plate which “held” by a transporter. The mechanical linkage may also be useful in removing the plate from the microscope stage. As an attachment or interface mechanism with the stage, the plate may include a metallic or magnetic insert for securing the plate to the stage.

In some embodiments, the plate may comprise a set of parallel slats within the well. These additional supports may be useful in the analysis of core biopsy samples. In some embodiments, these slats are narrower at the bottom surface to decrease the likelihood of reduced signal at the edge of the samples.

Both the plate and/or the cassette may be labelled to facilitate analysis and tracking. In some embodiments, the plate label comprises an RFID tag, a graphical symbol, a color, a barcode, or an alphanumeric code.

The wells of the plates can be sized to fit either standard or mega-sized sample cassettes. Accordingly, the wells may have dimensions of approximately 30 mm x 24 mm or 80 mm x 50 mm. In various embodiments, the wells may have a depth in a range of about 1 mm to about 6 mm or about 10 mm to about 15 mm.

The invention also provides for methods of loading a cassette into the disclosed multi-well plate. In some embodiments, a cassette is loaded by laterally inserting the cassette over the well. Pressure is applied to the cassette to deform the cassette against the projection on the central wall. Once deformed, the cassette is pushed down, near the peripheral edge to engage the resistance feature. To remove the cassette, it is pushed against the projection and lifted above the resistance feature.

In other embodiments, a cassette is loaded by laterally inserting the cassette under a lateral overhang on a sidewall and over the well until it contacts the one or more backstops. With tension against the backstop, the cassette can be fit between the backstop and the resistance feature. To remove the cassette, pressure is applied near the backstop to vertically displace one end of the cassette into an indentation, thereby lifting the opposite end above the resistance feature.

In some embodiments, a compressible material is placed between the cassette and the sample. In so doing, an even pressure may be applied across the sample.

### BRIEF DESCRIPTION OF THE DRAWINGS

FIG. 1 illustrates a top perspective view of a first exemplary multi-well plate according to one or more embodiment of the disclosure.

FIG. 2 illustrates a top perspective view of a second exemplary multi-well plate according to one or more embodiment of the disclosure.

FIG. 3 illustrates a bottom perspective view, including a window, of the first exemplary multi-well plate according to one or more embodiment of the disclosure.

FIG. 4 illustrates a top perspective view of the first exemplary multi-well plate including a well with spaced slats according to one or more embodiment of the disclosure.

FIG. 5 illustrates an enlarged bottom perspective view of the first exemplary multi-well plate including a well with spaced slats according to one or more embodiment of the disclosure.

FIG. 6 illustrates a top perspective view of the first exemplary multi-well plate including a positioned cassette according to one or more embodiment of the disclosure.

### DETAILED DESCRIPTION

The invention provides a multi-well plate for microscopy. In use, the wells of the plate may contain tissue specimens or samples such that multiple samples may be contained and analyzed by microscopy from a single plate.

Some embodiments of the disclosure can be understood by reference to the attached Figures. The plates illustrated in the Figures are merely exemplary and may illustrate features which are only present in some embodiments.

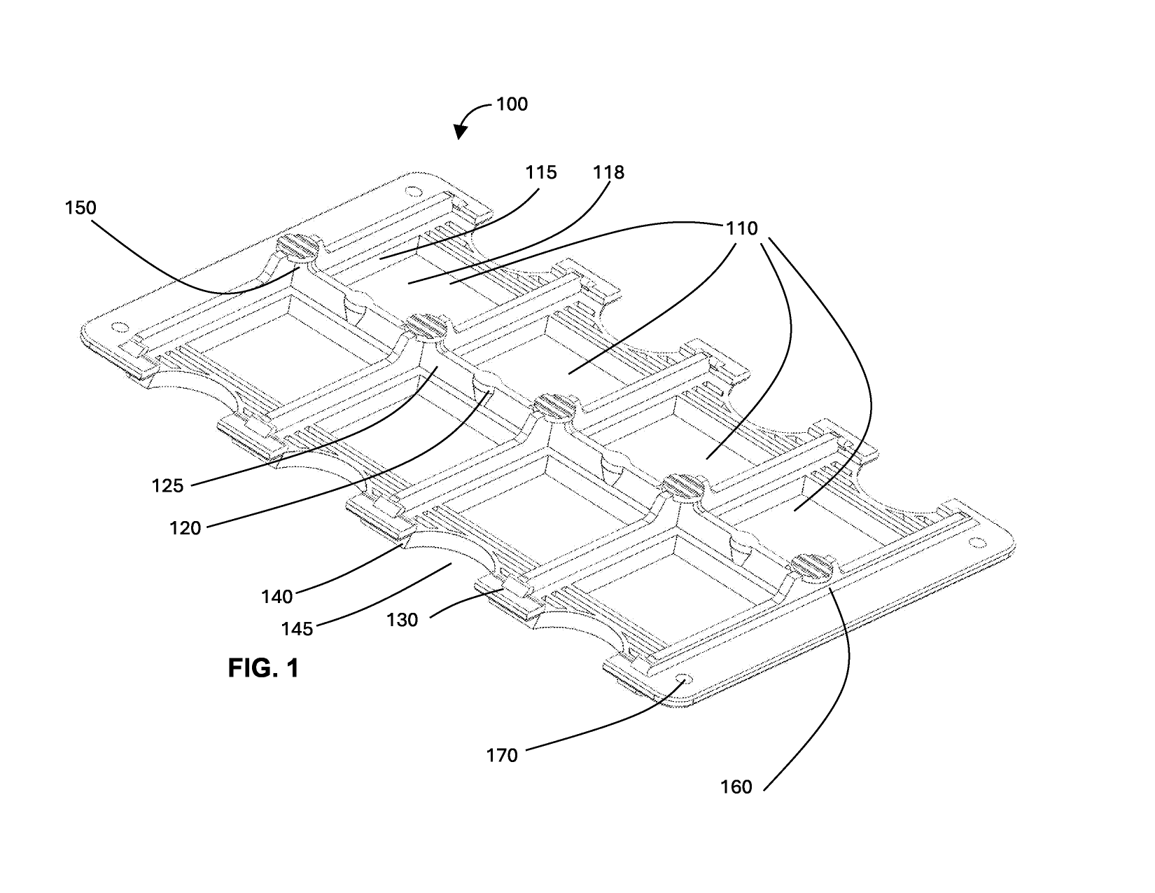

Referring to FIG. 1, the top of a tissue specimen microscopy plate 100 is shown. Throughout the disclosure, this apparatus may be referred to simply as a plate. The plate 100 comprises a plurality of wells 110. In some embodiments, the plate 100 contains 6, 8, 10, 12, or more wells. Each well 110 has sidewalls 115 and a bottom opening 118.

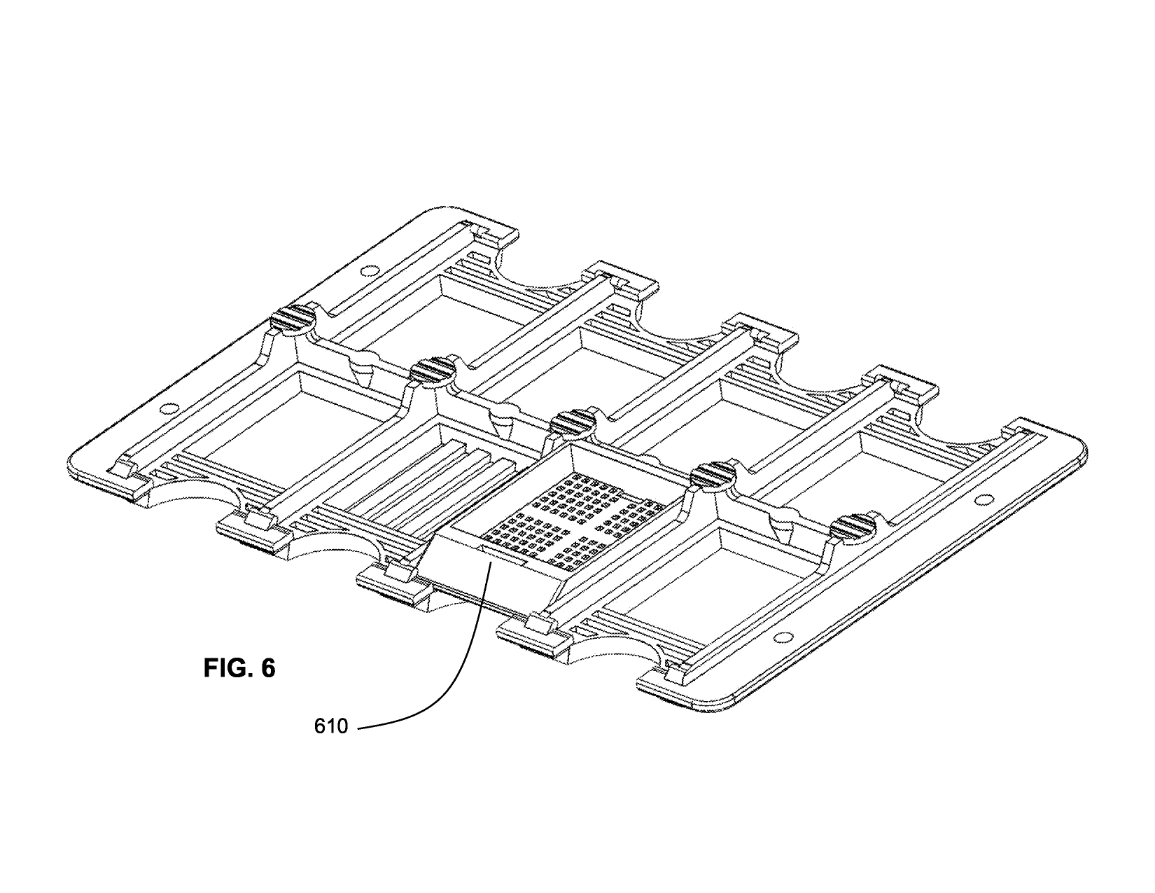

The plate 100 further comprises a set of physical features to secure a tissue specimen cassette (shown in FIG. 6, described below) over one of the plurality of wells 110. In use, the cassette 610 contains a sample within the well 110. The cassette 610 may be labelled with information regarding the identity of the contained sample. The label may be provided by manually writing on the cassette, attaching a label, or printing directly on the cassette (e.g., by using a cassette printer).

As shown in FIG. 1, the set of physical features may comprise a projection 120 on a central wall 125 and a resistance feature 130 on a peripheral edge 140. The resistance feature 130 may be understood as a “snap-on” feature where the cassette is held in place by counterbalancing forces.

Based on the embodiment illustrated in FIG. 1, the projection 120 provides pressure against a cassette rear wall when inserted into the plate 100 over well 110. In some embodiments, the central portion near the top of the rear wall of the cassette is most easily deformable and engages with the projection 120.

In some embodiments, the plate 100 may also include an indent 145 near the peripheral edge 140. The indent 145 may facilitate the removal of a cassette as described below.

In some embodiments, as shown, the set of features may also include a lateral overhang 150. The overhang may be useful to keep the cassette from being pushed upward.

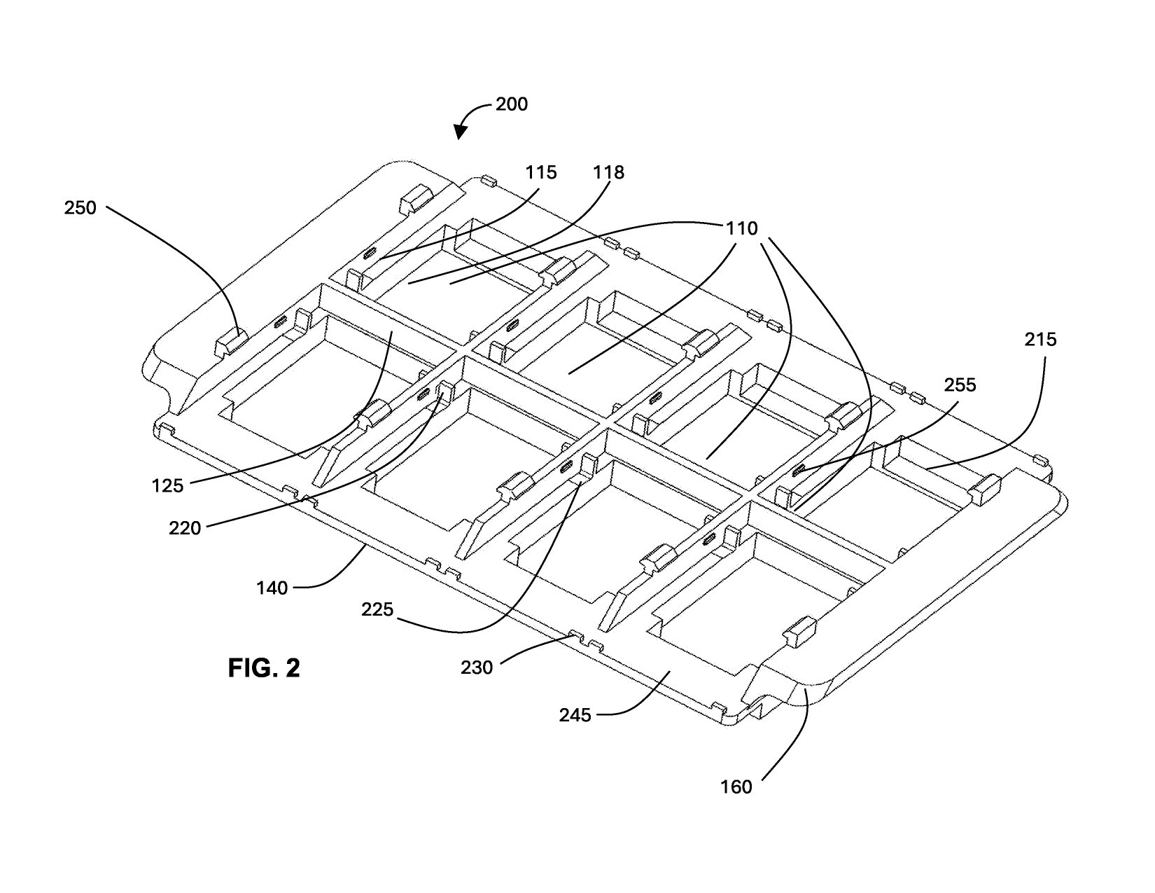

FIG. 2 illustrates a second exemplary plate 200. The features of the first plate 100 and the second plate 200 can be combined in any suitable combination. Dimensions disclosed herein with respect to plate 100 may also apply to plate 200. The plate 200 similarly comprises a plurality of wells 110. Each well 110 has sidewalls 115 and a bottom opening 118.

The plate 200 also further comprises a set of physical features to secure a tissue specimen cassette 610 over one of the plurality of wells 110. The cassette 610 may be labelled with information regarding the identity of the contained sample. Alternatively, plate 200 contains sufficient area near the peripheral edge 140 of each well 110 for the label to be applied in region 245. In either case, the label may be provided by manually writing on the surface of the plate or cassette, attaching an adhesive label, or printing directly on the plate or cassette (e.g., by using a cassette printer).

As shown in FIG. 2, the set of physical features may comprise one or more backstop 220 near the sidewall 215 and a retention feature 230 on a peripheral edge 140. In some embodiments, the retention feature 230 does not act as a “snap-on” feature but holds the cassette 610 is held in place without significant tension between the backstop 220 and the retention feature 230. The minimal tension, if any, facilitates the removal of the cassette 610. In some embodiments, the plate 200 may also include an indent 225 near the backstop 220. The indent 225 may facilitate the removal of a cassette as described below.

In some embodiments, the well 110 has a gap 215. The gap 215 increases the cross-sectional area of the well near the peripheral edge 140. The gap may be in any suitable shape, for example, rectangular (as shown) or semicircular. The gap 215 may facilitate the removal of a cassette as described below.

In some embodiments, as shown, the set of features may also include a overhang 250 projecting from the sidewall 115. The overhang 250 may be useful to keep the cassette from being pushed upward by the contained sample. While note shown, the sidewalls 115 may also contain horizontal ridges to help lock the cassette in place. These ridges may or may not correspond to matching ridges on the cassette. In some embodiments, the ridges are spaced about 200 µm apart. In some embodiments, the set of features includes a sidewall bump 255. The bump 255 may be useful to provide lateral resistance to inserted cassettes, helping ensure that the cassette does not shift.

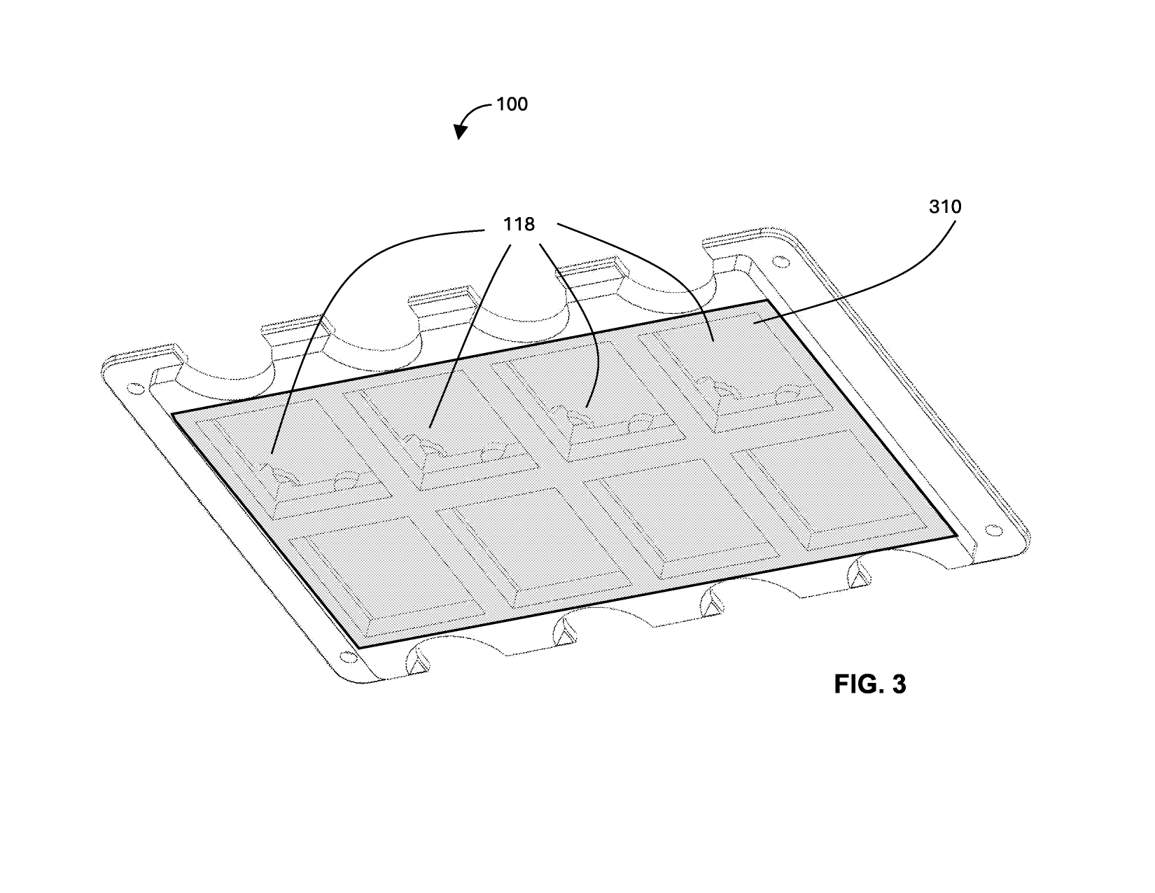

As shown in FIG. 3, the bottom opening 118 is covered by an index-matched optical window 310. In some embodiments, as shown in FIG. 3, the optical window 310 may extend to cover all of the openings 118. Alternatively, the optical window 310 may be sectioned to cover only one or more openings 118.

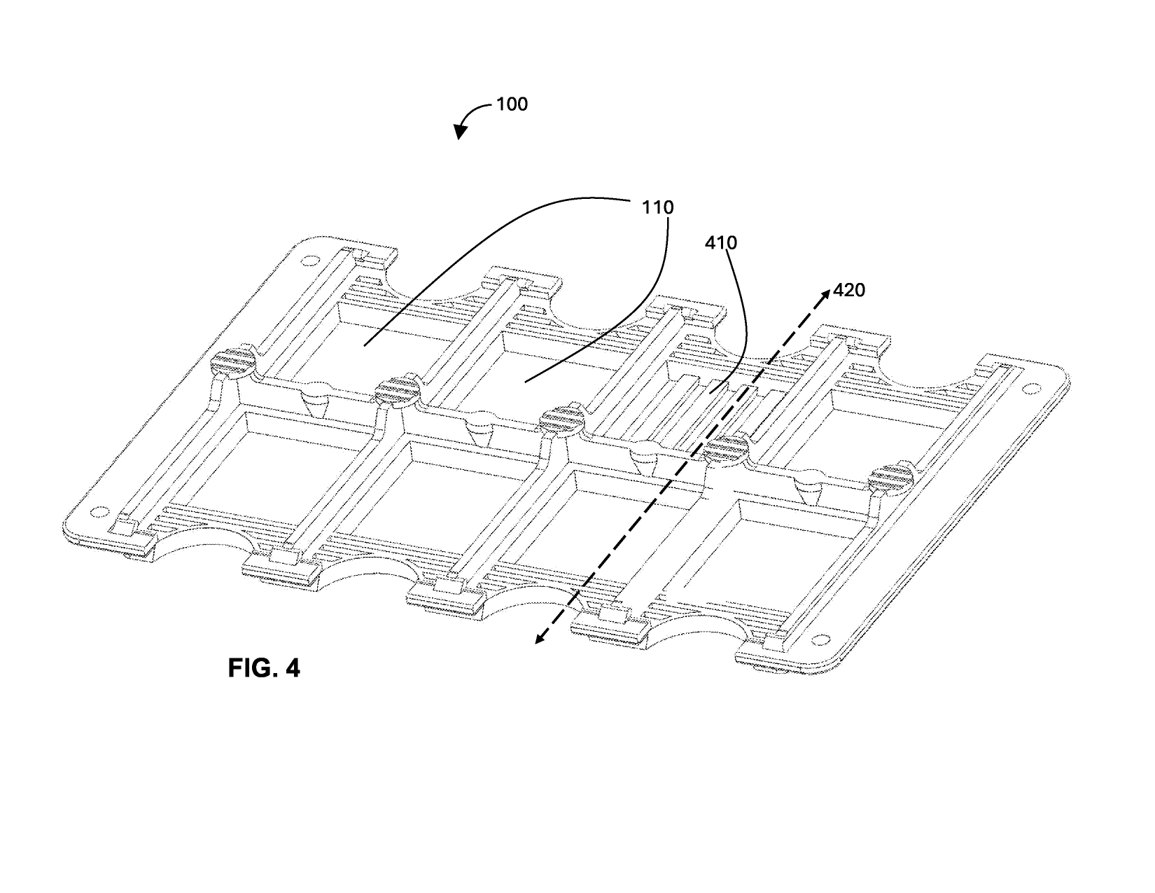

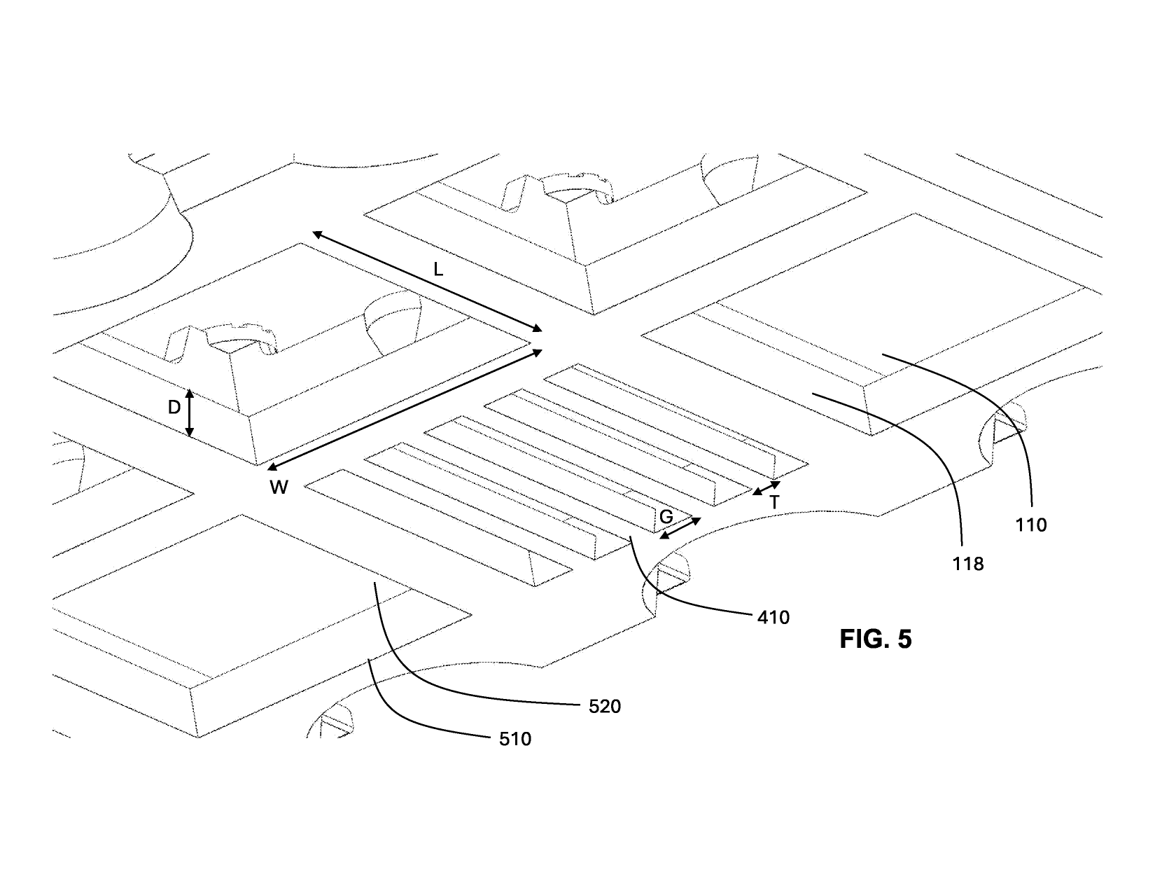

The material of the optical window 310 is typically either plastic or glass. A plastic window reduces the risk of the window fracturing under pressure, but the pliant nature of some plastics may introduce variability in the depth dimension of the plate, particularly when under pressure. For wide optical windows, the use of glass may be preferrable to reduce or resist deflection of the window from forces applied thereto by pressing a sample against the window. In contrast, thinner optical windows (mentioned below with respect to FIGS. 4 and 5, are less likely to produce deflection and may enable use with thinner windows.

The inventors have found that for imaging regions which are more than about 5 mm in the shortest dimension, window thickness can be between about 140 µm and about 700 µm, between about 200 µm and about 500 µm, between about 250 µm and about 500 µm, between about 500 µm and about 750 µm. In some embodiments, the window thickness is about 250 µm, about 500 µm, or about 750 µm. For wells (shown in FIGS. 4 and 5) which are designed to accommodate core biopsies and may have shortest dimension of less than 5 mm, a long narrow window between support areas (e.g., 3 mm wide), the window thickness can be between 10 µm and 150 µm, preferably between about 140 µm and about 150 µm.

The thinner windows produce less image degradation and increase the depth that can be imaged for these smaller samples in which accessing deeper into the specimen is more important.

The plate 100 may also contain a mechanical linkage. Alternative embodiments are shown in FIGS. 1 and 2, but the mechanical linkage may comprise a physical overhang 160. In some embodiments, the mechanical linkage may aid in lifting the plate, removing the plate from a magnetic base, or securing the plate during transport.

The plate may also contain a metallic or magnetic insert at region 170. The insert may be useful to secure the plate and minimize movement during imaging or other analysis. Accordingly, the insert may interface with metallic or magnetic elements in a microscope stage.

Referring to FIG. 4, one or more wells 110 of the plate 100 may contain a set of parallel slats 410. These slats may be useful in providing additional support and containment for smaller samples. Specifically, the inventors have found the slats useful in analyzing or imaging a set of core biopsies. When imaging core biopsies, the inventors recognize that thinner windows 310 may be more suitable. Accordingly, in these embodiments, the window 310may vbe

The slats 410 may be arranged to have a primary axis 420 that corresponds to the direction of stage motion during a polygon-based imaging procedure. In so doing, the inventors have found increased efficiencies by reducing the number of “strips” of data necessary to provide a complete image.

With respect to FIG. 5, the slats 410 are provided with a thickness T and a gap G. The thickness T and the gap G may be selected to accommodate specimens of differing sizes and spacing.

In some embodiments, the slats are provided with an angled surface that provides a smaller thickness towards the imaging surface 510 and a larger thickness towards a sample surface 520. Stated differently, in some embodiments, the slats 410 have a trapezoidal cross-section with a narrower width at the bottom opening 118 of the well 110.

In some embodiments, a specialized cassette is used for core biopsy samples. The specialized cassette comprises a surface with slots formed therein for receiving samples. A cassette may contain any number of slots, but in a preferred embodiment, the specialized cassette contains 6 slots. The slots are approximately 1-2 mm wide and 1-2 mm deep. The specialized cassette also comprises a cover with ridges corresponding to the slots. The cover is hinged to the cassette at a distal end. In use, the cover is slowly lowered to be in contact with the surface of the cassette, the ridges being within the slots. In so doing, capillary flow eliminates air bubbles from between the surface and the cover as the cover is lowered towards the surface.

While not shown in the Figures, the plate may comprise a label or designated labelling area. The label may be useful to identify the samples contained within the plate during imaging or other information including, but not limited to, sample source, sample preparation date/time, number of samples, geometry of imaging region, and thickness of imaging window 310. While any suitable label may be used, the label may be selected from an RFID tag, a graphical symbol, a color, a 2D barcode (QR code), a 1D barcode, or an alphanumeric code (containing letters and/or numbers).

The plate may be formed with any suitable dimensions. In some embodiments, each well of the plurality of wells is formed with the same dimensions. In some embodiments, the wells are formed with differing dimensions. Referring to FIG. 5, a well 110 may have a length L, a width W, and a depth D.

An opening 118 may have a length L and width W which correspond to a “standard” tissue cassette, specifically, about 30 mm x about 24 mm. The dimensions of a well may also correspond to a “mega” tissue cassette, specifically about 80 mm x about 50 mm.

The depth D of a well may range from about 1 mm to about 15 mm. In specific embodiments, a “standard” tissue cassette may be used with a well having a depth of about 1 mm to about 5 mm or about 5 mm. Similarly, in specific embodiments, a “mega” tissue cassette may be used with a well having a depth of about 10 mm to about 15 mm.

For all of the dimensions disclosed above, the dimension may have an acceptable degree of variance limited to ± 5 mm, ± 4 mm, ± 3 mm, ± 2 mm, ± 1 mm, or ± 0.5 mm.

Additional embodiments of the disclosure relate to methods of loading a plate for microscopy. While these methods are described with respect to the plates disclosed herein, the inventors have identified that similar methods would be useful if applied to other plates beyond the scope of this disclosure.

The methods being by laterally inserting a sample cassette over a well of a plate.

With reference to FIG. 1, in some embodiments, the plate 100 comprises a set of physical features comprising at least a projection 120 on a central wall 125 and a resistance feature 130 on a peripheral edge 140 opposite the central wall 125. In some embodiments, the plate 100 comprises a lateral overhang 150 and the cassette is angled beneath the overhang 150.

The cassette is inserted with an applied pressure so as to deform an edge of the cassette as it contacts the projection 120. This deformation of the cassette provides a counteracting pressure which attempts to push the cassette out laterally. The method continues by pushing the cassette down to engage a resistance feature 130 of the plate 100. This motion “snaps” the cassette in place, under pressure, as the counteracting pressure from the projection 120 is balanced by pressure from the resistance feature 130. An inserted cassette 610 is shown in FIG. 6.

Stated differently, in some embodiments, the process of loading the cassette is to slide the distal end under the overhang 150, then pushing down on the front, proximal portion to have it “snap” past the resistance feature 130. The projection 120 keeps the cassette pushed up against the underside of the resistance feature 130.

To remove, the cassette is pushed straight backwards to move the cassette past the resistance feature 130. In so doing, the cassette can be held using indent 145 and lifted up. The cassette is then slid out from under the overhang 150.

With reference to FIG. 2, in some embodiments, the plate 200 comprises a set of physical features comprising at least a backstop 220 near a sidewall 115 and a retention feature 230 near a peripheral edge 140 opposite the central wall 125. In some embodiments, the plate 100 comprises a lateral overhang 250 and the cassette is slid beneath the overhang 250.

The method continues by inserting the cassette laterally until it meets the backstop 220. At this time, the cassette has advance beyond the retention feature 230. The arrangement of the feature of plate 200 does not put significant tension between the backstop 220 and the retention feature 230. In this way, the materials of the plate and the cassette are advantageously less likely to degrade over time from having to hold significant tension/stress.

Stated differently, in some embodiments, the process of loading the cassette is to slide the distal end under the overhang 250, advancing the cassette until it meets backstop 220 and placing the cassette in front of retention feature 230 so that the cassette rests in its lateral position over well 110.

To remove, the cassette is pushed down, near the backstop 220 into indent 225. This motion elevates the proximal edge of the cassette which can be held using gap 215.The cassette can be securely slid under overhang 250, away from the central wall 125, and removed from the plate 200.

According to some embodiments of the disclosure the disclosed methods further comprise providing a tissue sample to the well before inserting the sample cassette. Further some embodiments may comprise providing a compressible material within the well after providing the tissue sample and before inserting the sample cassette.

For these embodiments, depending on the volume of the well, the inserted cassette 610 may apply a compressive force against the compressible material or the tissue sample to push the sample against the optical window 310. The use of the compressible material provides more even pressure on the sample against the optical window.

The compressible material may be selected to be tolerant of clearing liquids (e.g., benzyl alcohol, benzyl benzoate). In some embodiments, the compressible material is nylon.

While many of the following benefits are discussed elsewhere in the disclosure, the inventors have found that the disclosed apparatus and methods may provide one or more of the following benefits:

The disclosed plates facilitate the simultaneous processing of multiple tissue samples within the same plate. In some embodiments, the plates contain 8 wells. This increases throughput compared to handling each sample individually.

The disclosed plates provide increased sample integrity and safety. With wells specifically designed to accommodate individual tissue specimens, the disclosed plates reduce the risk of cross-contamination, loss, or damage to the samples.

The disclosed plates improve consistency and repeatability. By providing uniform conditions for fixation, embedding, and staining across all wells, the disclosed plates enhance experimental consistency and increase the repeatability of results.

The disclosed plates improve time and resource efficiency. The plates provide automated compatibility, reduce manual labor requirements, and streamline workflows. These benefits enable faster processing, reduce mislabeling risk, and provide cost savings by reducing reagent usage and personnel time.

The disclosed plates provide enhanced imaging capabilities. By utilizing an index-matched optical window, the plates facilitate high-resolution microscopy without the need to remove specimens from the plate. This preserves the sample’s integrity and positioning.

The disclosed plates simplify sample tracking. The integration of 2D barcodes, symbols, and/or RFID technology aids in the automated tracking and logging of samples through processing stages, minimizing human error associated with manual sample management.

The disclosed plates provide an increased versatility of use. Modular designs including variable well sizes and depths accommodate different tissue sizes and types, from larger organ sections to small biopsies.

The disclosed plates provide automation-readiness. Their compatibility with laboratory automation systems allows for seamless incorporation into existing high-throughput workflows for imaging and fluid exchange processes.

The disclosed plates provide improved sample organization. The use of pre-labeled cassettes affixed to sample wells and/or direct labelling of individual sample wells enables the clear identification and organization of specimens throughout the processing stages.

The disclosed plates provide enhanced compatibility with large imaging surfaces. The option for thicker imaging plates provides added structural integrity, reducing flex and ensuring stable imaging conditions for large imaging regions.

The disclosed plates provide an increased convenience in handling. By including magnetic or metallic elements incorporated into the plate, the plates provide secure attachments to laboratory instruments, reducing the risk of accidental spills or mishandling.

The disclosed plates provide customization options. Different versions of the plate can cater to specific experimental needs or space constraints within laboratory equipment.

The disclosed plates also provide standardization potential. The plates’ ability to interface with standard tissue cassettes introduces the possibility of establishing standardized histological processing procedures across institutions.

Finally, the plates increase the portability of samples. Through a removable cassette mechanism, processed tissues can be easily relocated for further analysis or storage without compromising their condition.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification, and guidance that can be adapted to the practice of this invention in its various embodiments and equivalents thereof.

What is claimed is:

1. A tissue specimen microscopy plate comprising:
a plurality of wells, each well having sidewalls and a bottom comprising an index-matched optical window; and
a set of physical features to secure a tissue specimen cassette over one of the plurality of wells.

2. The plate of claim 1, wherein the set of features comprises a projection on a central wall and a resistance feature on a peripheral edge of the plate.

3. The plate of claim 1, wherein the set of features comprises a backstop near a sidewall and a retention feature near a peripheral edge of the plate.

4. The plate of claim 1, wherein the set of features further comprises an overhang.

5. The plate of claim 1, further comprising a mechanical linkage.

6. The plate of claim 5, wherein the mechanical linkage comprises a physical overhang.

7. The plate of claim 1, further comprising a metallic or magnetic insert configured to interface with a microscope stage.

8. The plate of claim 1, wherein at least one of the wells comprises a set of parallel slats within the well.

9. The plate of claim 8, wherein the set of parallel slats have a trapezoidal cross-section with a narrower width at the bottom of the well.

10. The plate of claim 1, wherein the plate further comprises a label.

11. The plate of claim 10, wherein the label comprises an RFID tag, a graphical symbol, a color, a barcode, or an alphanumeric code.

12. The plate of claim 1, wherein at least one well has dimensions of 30 mm x 24 mm (± 4 mm).

13. The plate of claim 1, wherein at least one well has a depth in a range of about 1 mm to about 6 mm.

14. A method of loading a multi-well plate, the method comprising:
laterally inserting a sample cassette over a well of the plate of claim 2;
applying pressure to the cassette to deform the cassette against the projection on the central wall; and
pushing the cassette down to engage the resistance feature.

15. The method of claim 14, further comprising providing a tissue sample within the well before inserting the sample cassette.

16. The method of claim 15, further comprising providing a compressible material within the well after providing the tissue sample and before inserting the sample cassette.

17. A method of loading a multi-well plate, the method comprising:
laterally inserting a sample cassette over a well of the plate of claim 3;
advancing the cassette to the backstop; and
releasing the cassette once advanced beyond the retention feature.

18. The method of claim 17, further comprising providing a tissue sample within the well before inserting the sample cassette.

19. The method of claim 18, further comprising providing a compressible material within the well after providing the tissue sample and before inserting the sample cassette.
